(19) United States
(12) Patent Application Publication
(10) Pub. No.: US 2012/0197900 A1
(43) Pub. Date: Aug. 2, 2012

(54) SYSTEMS AND METHODS FOR SEARCH TIME TREE INDEXES

(75) Inventor: Sateesh Mandre, Bangalore (IN)

(73) Assignee: Unisys Corporation, Blue Bell, PA (US)

(21) Appl. No.: 13/024,558

(22) Filed: Feb. 10, 2011

(30) Foreign Application Priority Data
Dec. 13, 2010 (IN) 2968/DEL/2010

(51) Int. Cl. G06F 17/30

(52) U.S. Cl. 707/743; 707/E17.083

(57) ABSTRACT

A system and method for searching a time tree index for a database table, where the index uses time representations. A request for data is received, the request comprising a search value. A search date value is derived. The search date value comprises at least one time unit selected in order from a largest time unit to a smallest time unit from the list: century, year, month, date, hour, minute, second and millisecond. A time tree index is searched for at least one node, such that the index path to the node comprises the search date. At least one data record associated with the node is retrieved.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates to systems and methods for indexing databases, and more particularly to systems and methods for indexing database tables using time representations.

### BACKGROUND

Database systems are used to store large amounts of information. Such information can be stored, in the case of relational database systems (RDBMS), in one or more tables which may have logical relationships with one another. Database managements systems commonly employ indexes to facilitate and speed access to tables in databases managed by such systems. Various indexing schemes have been developed to support indexing database tables such as, for example, the B− tree and B+ tree indexing schemes.

A B− tree can be viewed as an hierarchical index. The root node is at the highest level of the tree, and may store one or more pointers, each pointing to a child of the root node. Each of these children may, in turn, store one or more pointers to children, and so on. At the lowest level of the tree are the leaf nodes, which typically store data records or addresses to data records. B tree and B+ trees thus provide the navigation path to the address of database records in database tables.

Various implementations of B− tree and B+ tree indexes, however, suffer from a number of drawbacks. First, B− tree and B+ tree indexes have nodes that store key values for records at all the levels of the index. Second, the search time with B− tree and B+ tree indexes increases with the size of the data base table. Third, it is not easy to define and use fixed memory allocation arrays for the higher levels of such indexes as the size of the index tree may change during database reorganization. Fourth, time based queries that need information on when a database record is created cannot be provided to the required time point like date, hour, minute and seconds. Such queries typically cannot be answered unless a field is added to the record to store the time of creation of record.

### SUMMARY OF THE INVENTION

A system and method are provided for searching a time tree index for a database table. A request for data is received using a computing device, the request comprising a search value. A search date value is derived, using the computing device. The search date value comprising at least one time unit selected in order from a largest time unit to a smallest time unit from the list: century, year, month, date, hour, minute, second and millisecond. A time tree index is searched, using the computing device, for at least one node, such that the index path to the node comprises the search date. At least one data record associated with the node is retrieved using the computing device.

### BRIEF DESCRIPTION OF THE DRAWINGS

The foregoing and other objects, features, and advantages of the disclosed system and method will be apparent from the following more particular description of preferred embodiments as illustrated in the accompanying drawings, in which reference characters refer to the same parts throughout the various views. The drawings are not necessarily to scale, emphasis instead being placed upon illustrating principles of the disclosed system and method.

FIG. 1 illustrates a portion of one embodiment of a time tree index

FIG. 2 illustrates an example of a balanced time tree 200.

FIG. 3 illustrates an example of an unbalanced time tree 300.

FIG. 4 illustrates one embodiment of a more detailed view of an index node 420 and a leaf node 480 in a time tree index which could correspond to index level nodes and leaf nodes in FIGS. 2 and 3.

FIG. 5 illustrates one embodiment of an example of a balanced time tree index prior to record deletion.

FIG. 6 illustrates one embodiment of an example of the balanced time tree index of FIG. 5 after record deletion.

FIG. 7 illustrates one embodiment of an example of the balanced time tree index of FIG. 6 after reorganization.

FIG. 8 illustrates one embodiment of an example of the unbalanced time tree index of FIG. 3 after record deletion.

FIG. 9 illustrates one embodiment of an example of the unbalanced time tree index of FIG. 8 after reorganization.

FIG. 10 illustrates one embodiment of a database server 1000 capable of supporting a time tree indexing.

FIG. 11 illustrates one embodiment of a process 2000 for creating, building and using a balanced tree.

FIG. 12 illustrates one embodiment of a process 3000 for searching a time tree index for data relating to a key value.

FIG. 13 is a block diagram illustrating an internal architecture of an example of a computing device 5000, such the database server of FIG. 10, in accordance with one or more embodiments of the present disclosure.

### DETAILED DESCRIPTION

The subject system and method are described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

In some alternate implementations, the functions/acts noted in the blocks can occur out of the order noted in the operational illustrations. For example, two blocks shown in succession can, in fact, be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure a computer readable medium stores computer data, which data can include computer program code that is executable by a processor in a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

The instant disclosure is directed to systems and methods for providing hierarchical indexes for database tables using an index structure that reflects date and times, referred to hereinafter as “time-tree” indexes. Index creation starts either with mapping the record field value, being indexed, to a predefined set of strings or by mapping the date-time stamp to a predefined set of strings. The indexing will never store a field value directly in the index tree node. Such indexes for database tables reduce the search time for the database records by providing a definite path to the record location. A time-tree index can be generated for every record for any field in a database table, even fields which are non-unique and not directly or indirectly based on a date-time value.

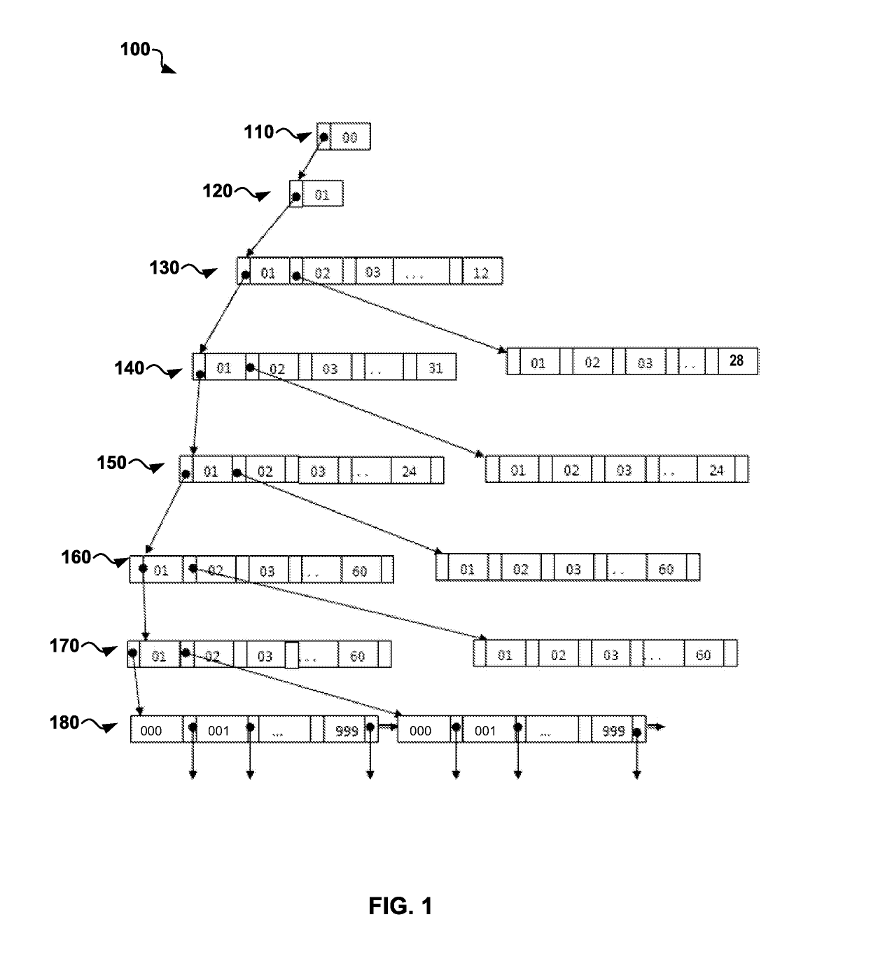

FIG. 1 illustrates a portion of one embodiment of a time tree index 100. The index includes a roof node 110 corresponding to a century and seven levels comprising nodes corresponding to years 120, months 130, dates 140, hours 150, minutes 160, seconds 170, and milliseconds 180. The nodes at each level are sorted in ascending order from left to right (e.g. 01→60, etc.). All the values from left to right form a set where each element is unique. In one embodiment, nodes at the lowest level of any given branch of the tree are leaf nodes (e.g. point to data records). The illustrated embodiment is purely exemplary, and other embodiments could comprise fewer levels (e.g. no deeper than minutes 160), or more levels (e.g. nanoseconds). For clarity, the embodiments discussed herein generally contain seven levels (i.e. microseconds) or less.

In the embodiment illustrated in FIG. 1, the path to a specific data record is defined by an index value comprising a date and a time. Such index values may relate, directly or indirectly, to the data in the records to which they point. By way of non-limiting example, such index values may represent the time of creation of entities such as events, data objects, processes, and so forth along a time axis. In such an exemplary embodiment, the index created is a time index. Time indexing is purely on date-time stamp value in order of creation of records.

In alternative embodiments, the value of a database field, such as a unique primary key could be algorithmically translated to a date and time value. Such values may or may not have any significance as dates or time, per se. In fact, such index values may have no relationship to the time of creation of the records to which they point. For example, a time tree index could be used to index a key field in a database table. In such an embodiment, the index values may not have any significance as dates and times, but rather simply represent an abstract data path to a given data record. In one such embodiment, a separate data store can be maintained to map key values to representations of date and time values that can, in turn be used to locate data records. In an alternative embodiment, a mapping algorithm can be used to map the field value to the T-Point. This creates a non-cluster index on record fields.

In some embodiments, a time tree index can be frozen at a specific level, which is to say, index records are created down to at least that level. For example in the case of a tree index representing records created under a date, the freeze level can be set to date level. In such case the tree index has a minimum depth of 4 representing century, year, month and date, with leaves at the hour level. In one embodiment, if a tree represents transactions at the second level then the index is frozen is on the second level, and leaves start at millisecond level. The level at which an index is frozen determines how and when the tree is reorganized during addition and deletion operations, as described in more detail below. For a non-cluster index, where the date and time is not significant, the tree will not have a defined freeze level.

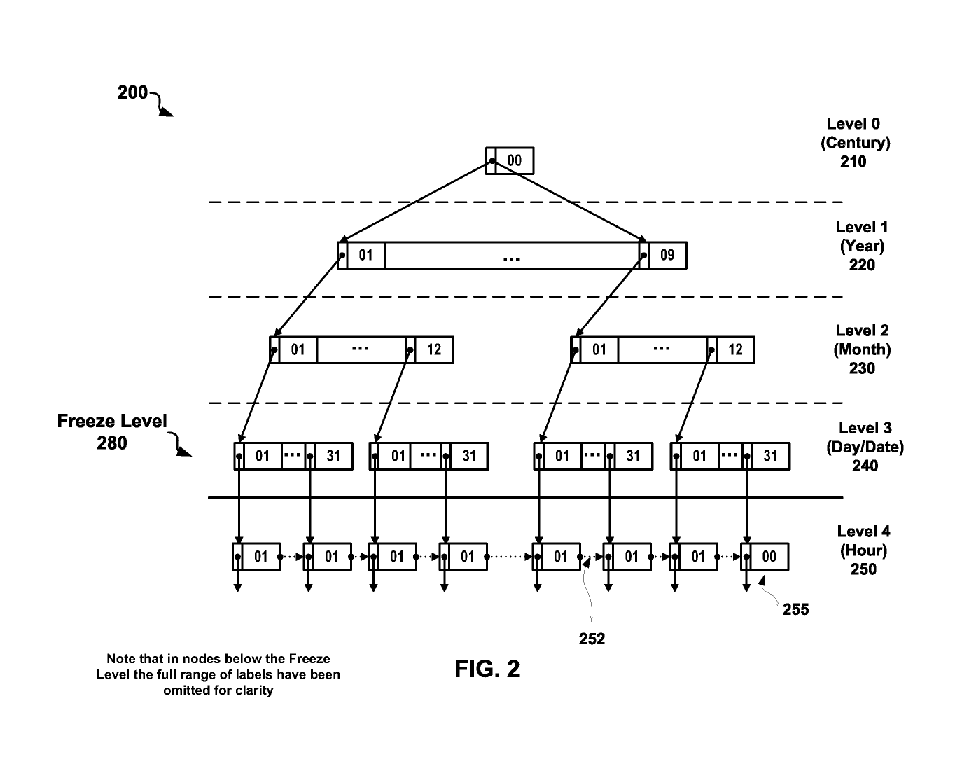

Time tree indexes can be either balanced or unbalanced. If the tree is balanced, all leaf nodes can be found at the same level. In this case, the depth of the tree remains the same for all leaves and this constraint can be applied while performing node addition and node deletion operations. In the case of unbalanced trees, the leaves can be at different levels below a freeze level. FIG. 2 illustrates an example of a balanced time tree 200. The time tree has levels corresponding to century 210, year 220, month 230, date 240 and hour 250. The freeze level 280 for this time tree is on date (i.e. century, year, month and date), and all leaf nodes are found at the hour level 250. The freeze level can be defined as being at any level in these time trees.

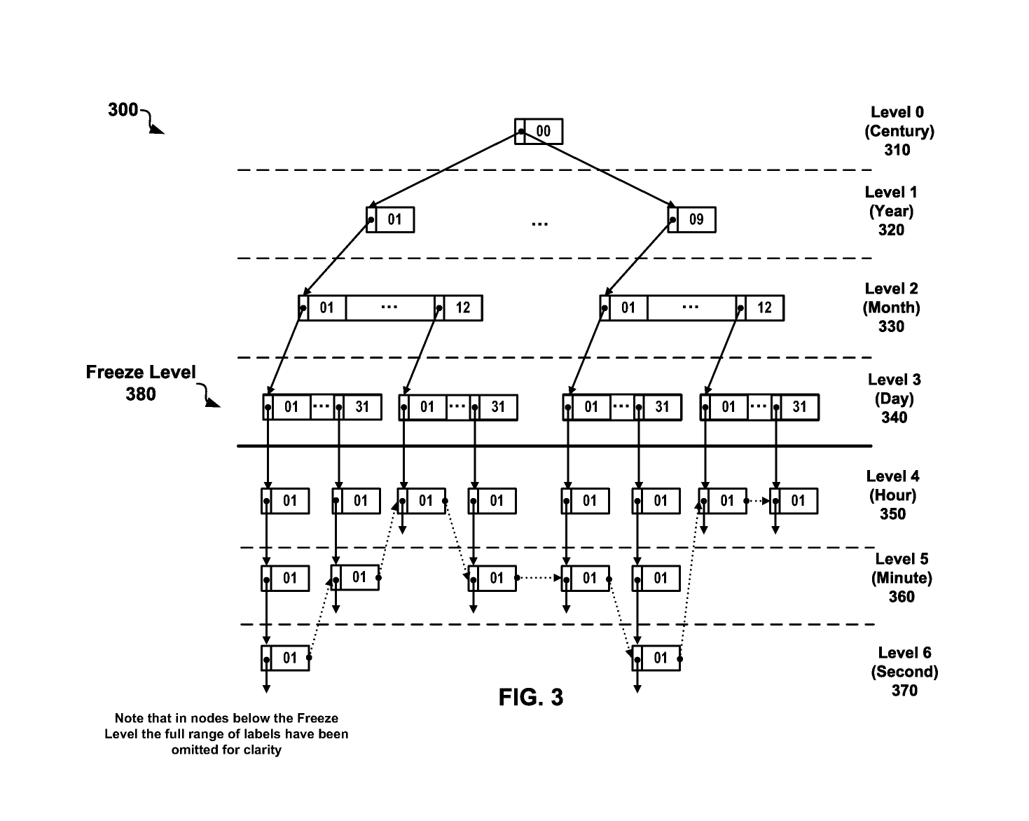

FIG. 3 illustrates an example of an unbalanced time tree 300. The time tree has levels corresponding to century 310, year 320, month 330, date 340, hour 350, second 360, and millisecond. The freeze level 380 for this time tree is also on date (i.e. century, year, month and date), and all leaf nodes are therefore found at or below the hour level 350. The unbalanced time tree allows for a varying length of an index path to leaf nodes, and leaf nodes can exist at the hour 350, second and millisecond level 370. The unbalanced time tree can be more appropriate when, for example, the number of data records indexed can vary greatly for a given date. In such an exemplary embodiment, if the freeze level 380 is at the date level, leaves can be created first at hour level 350, then at minute level 360, then at second level 370, allowing for a variable length of the index path for a given date. In such a case, the time values below the freeze level are typically not significant as time values, per se, but are more closely akin to a sequence number.

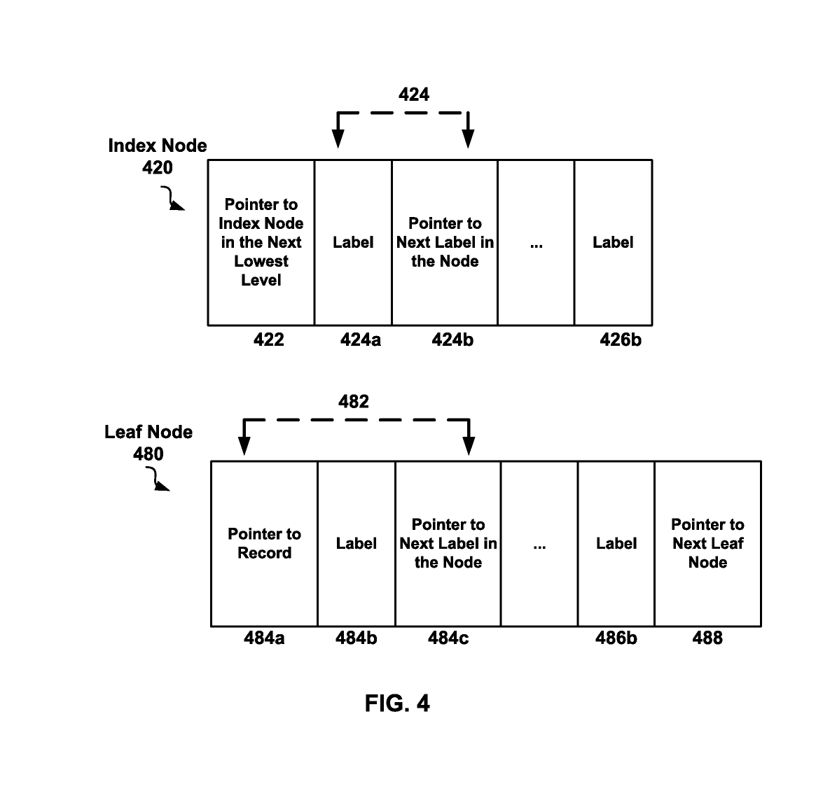

FIG. 4 illustrates one embodiment of a more detailed view of an index node 420 and a leaf node 480 in a time tree index which could correspond to index level nodes and leaf nodes in FIGS. 2 and 3. Each of the nodes 420 and 480 in the index includes sufficient space for, or could be expanded to include, labeled entries, 424 or 484, for each of the full range of node values at that level. For example, referring to FIG. 2, nodes at Level 2 (Month) 230 could include sufficient space for 12 entries. In one embodiment, such entries are not actually added to the node until an index value including a date which utilizes that node entry is needed.

In one embodiment, an index node comprises a pointer 422 to the next lowest level in the index and one or more labeled entries 424. Each labeled entry 424 comprises a label 424a comprising a unique node value and a pointer 422b to the next label in the node. In one embodiment, the index node comprises a plurality of labeled entries 424, one for each node value reflected in the index. In one embodiment, the labeled entries 424 are sorted in order by the values of their respective label 424a. The index node ends with the label 426b for the highest node value in the node 420.

In one embodiment, an index node comprises one or more labeled entries 484 and a pointer 488 to the next leaf node in the index. Each labeled entry 484 comprises a pointer 484a to a data record, a label 484b comprising a unique node value and a pointer 484c to the next label in the node. In one embodiment, the index node comprises a plurality of labeled entries 424, one for each node value reflected in the index. In one embodiment, the labeled entries 484 are sorted in order by the values of their respective label 424a. The index node ends with the label 486b for the highest node value in the node 420, followed by a pointer 488 to the next leaf node in the index.

Referring back to FIG. 2, in one embodiment, each labeled entry in a node points to one, and only one, node in the next lowest level in the index, except in the case of leaf nodes 250, which point to data records. In one embodiment, the leaves from left to right form a linked list where the one leaf 252 points to the next leaf in order from left end to right end of the tree. A maximum number of labels a node can have is predefined and is dependent on the level in which the node is defined. For example, the node in month level will have 28 OR 29 OR 30 OR 31 labels based on the month type and leap year. These labels represent dates in this level. Table 1 defines the label ranges for each level of a time tree index.

The order (branching factor) of a time tree measures the capacity of nodes (i.e. the number of children nodes) at each level of the tree. The order of the tree at each level is different and fixed.

TABLE 1

| | | | Number of Nodes |
|---|---|---|---|
| Tree Level | Time Unit | Label Range | for each time unit |
| 1 | Year | [01] | 1 |
| 2 | Month | [01-12] | 12 |
| 3 | Date | [01-Month End] | 28 or 29 or 30 or 31 |
| 4 | Hour | [01-24] | 24 |
| 5 | Minute | [01-60] | 60 |
| 6 | Second | [01-60] | 60 |
| 7 | Millisecond | [006-999] | 1000 |

The traversal path from the root to each leaf in the tree forms a unique string of node labels. This string of node labels from the root to the leaf can be referred to as a time point or T-Point. In one embodiment, the T-Point starts at the year (root+1) level and can end anywhere at or before the millisecond level. In other embodiments, where index values span multiple centuries, the T-Point could begin at the root level. T-Point represents time of creation of the records in the index tree. Similar to a cluster index per the table, one time index can be created per table based on date-time stamps of record additions. When the indexing is made for key fields the T-Point doesn't represent date & time and simply maps the field being indexed to the label's string in the tree that denotes the path to navigate the record from the root node. In balanced tree, the length of the T-Point is the same for all leaves and in unbalanced tree the T-Point length can vary from node to node.

Each index node at the freeze level 280 has at least one leaf node. In one embodiment, index nodes down to the freeze level 280 could be pre-populated for a given date range, or more typically, nodes can be created at the freeze level as data relating to a T-Point under a given freeze level date are added to the index. Every index value added to a balanced tree index will be added down to the freeze level+1. For example, the embodiment of a balanced tree index illustrated in FIG. 2 is frozen at date level, and nodes are created to the hour level (freeze level+1). Every T-Point for this index always extends to the freeze level+1.

In the case of an index based on a single century, depending on the freeze level, there can be different levels in the tree from a minimum of 1 (year level) to a maximum 7 (millisecond level). The T-Point represents a path to reach each leaf in the tree and is unique path in the tree. All the T-Points from left to right define a set of elements to which they point.

In one embodiment, when a given freeze level node has been pre-populated, or if all of the leaf nodes under the freeze level node are deleted, the freeze level node points to a zero labeled leaf node, since every node in a balanced tree index, except the leaf level, must point to at least one node in the next level of the index (e.g. every node in the index participates in a path down to a node at freeze level+1). Also, when all the leaves in the leaf node have label ‘00’ due to deletion, it may be advantageous for the corresponding freeze node label to become ‘00’. This allows search operations to avoid visiting the leaf nodes with ‘00’ labels. Alternatively, if all of the leaf nodes under a given freeze level node are deleted, the freeze level node could be deleted. Any parent node can be deleted, if all of its children nodes have labels ‘00’ only. This reduces the search time as well as the size of the index tree.

If nodes at the freeze level are actually deleted, however, higher levels of the index are affected and may require reorganization. At a minimum, the entry for the deleted freeze level node must be removed, or set to zero, in the parent of the freeze level node. Such changes could cascade all the way up the index hierarchy. On the other hand, if leaf level nodes for deleted index values are simply set to zero, such cascading changes need not be made. If a substantial portion of leaf level nodes become null (zero labeled), it may be appropriate to completely reload or fully reorganize the index.

If the indexing is a time index then the deletion of any node may require reorganization for its parent node only and not for entire tree. This is because indexing will represent the time of creation of the event. Hence the deletion of particular node will simply comprise a removal of events on that point of time. This should not change the date-time stamp for other events and hence may not result in entire tree reorganization.

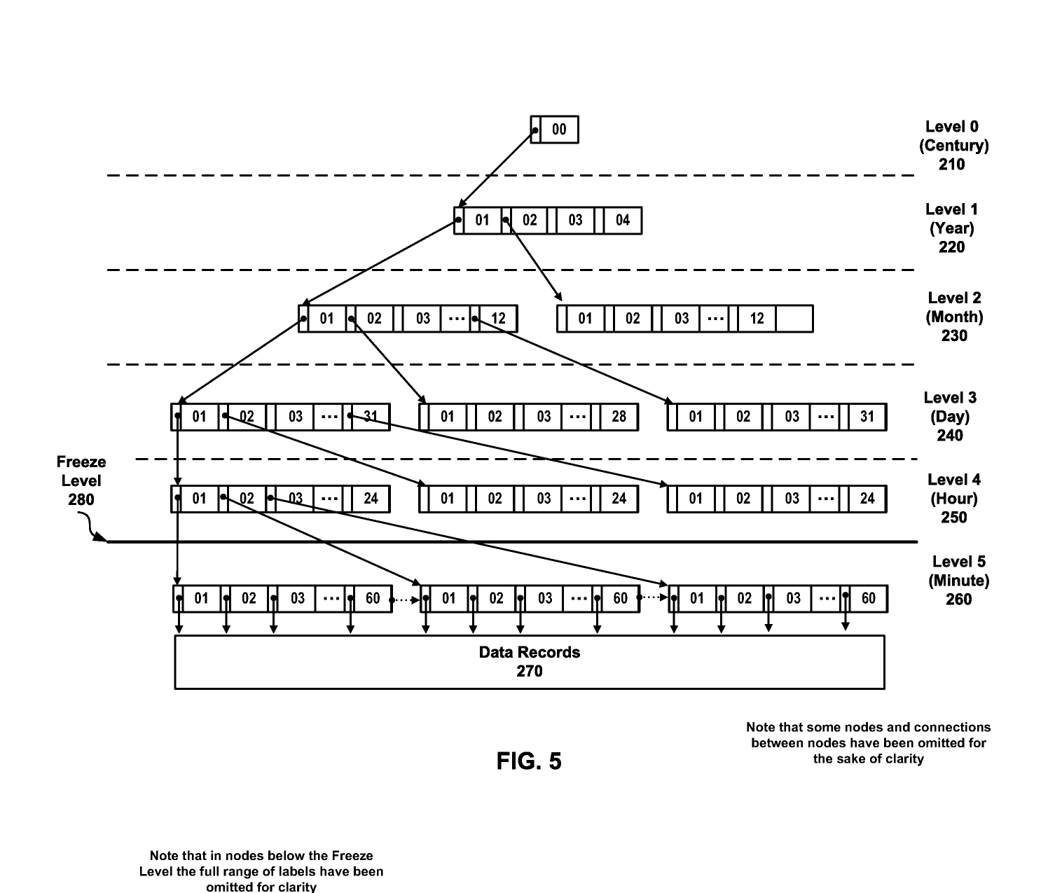

FIGS. 5-7 illustrate an exemplary embodiment in which records in a tree index are deleted, and the subsequent reorganization of all, or a portion, of the index. FIG. 5 illustrates a portion of a balanced tree index similar to that illustrated in FIG. 2. The embodiment illustrated in FIG. 5 has 6 levels and a freeze level 280 at the hours level 260. In the illustrated embodiment, leaf nodes exist at level 5, i.e. the minute level 260, and point to data records 270 external to the index.

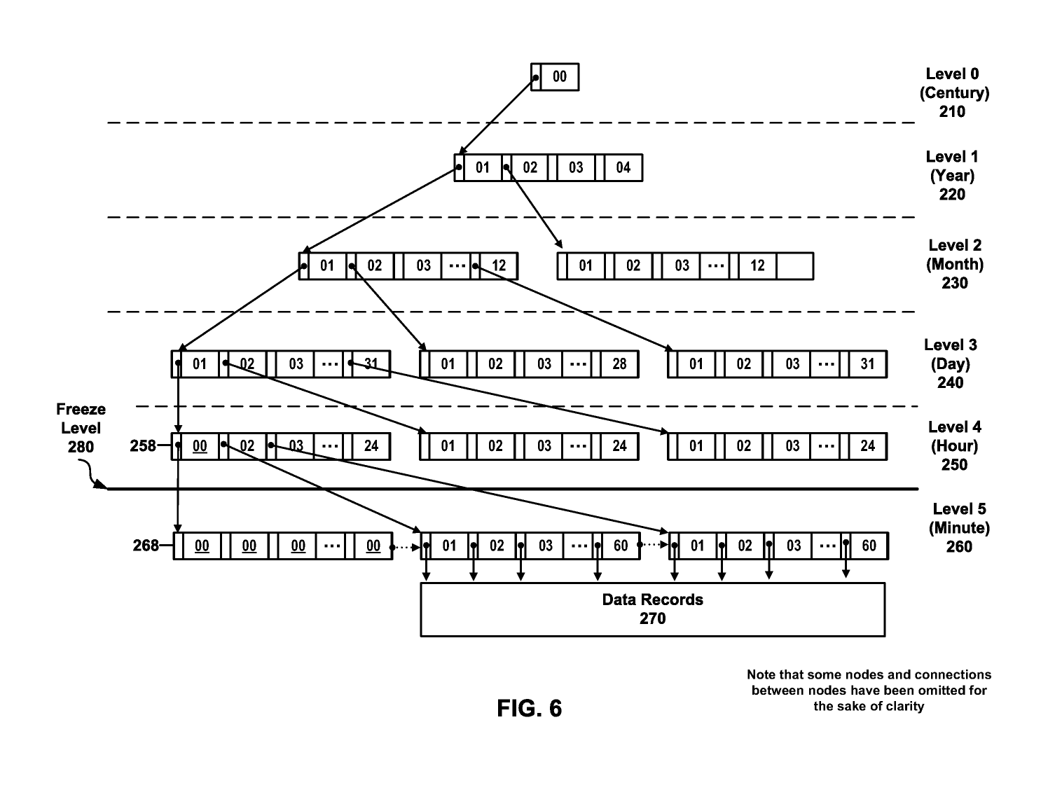

FIG. 6 illustrates the index of FIG. 5 after all index entries relating to century 00, year 01, month 01, date (day) 01, and hour 01 have been deleted. In the illustrated embodiment, all labels in the leaf node 268 have been set to “00”. Pointers to data records 270 in the node 268 can be set to zero or null, but need not be. Such zero or null data record values can be advantageous in some embodiments, since node entries labeled “00” can be ignored in such embodiments when the index is searched. In the index node 258 pointing to the leaf node, the node entry for hour “01” has been set to “00” to reflect the fact that it points to a child node whose labeled entries are all labeled “00”. The node entry for hour “01” is not set to “00” if there is one or more non-“00” labeled entry in a child node to which the entry points.

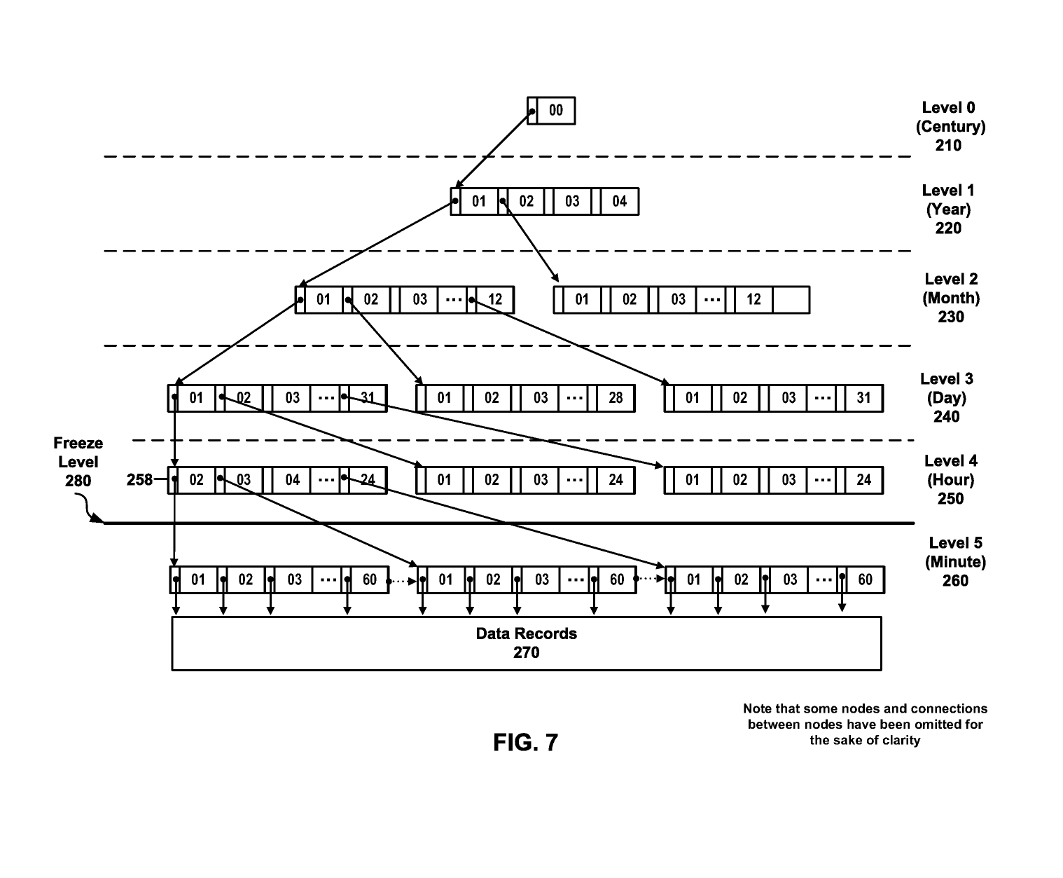

FIG. 7 illustrates the index of FIG. 6 after the index has been reorganized. The leaf node 268 of FIG. 6 for hour “01” has been removed from the index, and the labeled entry for hour “01” has been removed from the index node 258. Such a reorganization could be achieved through a reorganization of the entire index, but could also be achieved by reorganizing, only that portion of the index under node 258. Such a limited reorganization can be particularly appropriate in the case of a time index that represents the time of creation.

On the other hand, in the case of a non-cluster index, where index T-Points have no relation to the time of creation of the record, a full reorganization can be used to utilize the deleted label paths. In such a case, after reorganization, the index would resemble that illustrated in FIG. 5, except that labeled entries for the leaf node for hour “01” (and possibly all other leaf nodes) would now point to different data records 270.

In one embodiment, deletion and reorganization of index entries in an unbalanced time tree is analogous. As data records are deleted from the index, the corresponding labeled entry is set to “00” in the corresponding leaf node. When all labeled entries for a leaf node are set to “00”, the corresponding labeled entry in the parent node is set to “00”. In one embodiment, such changes can cascade up multiple levels in the index tree.

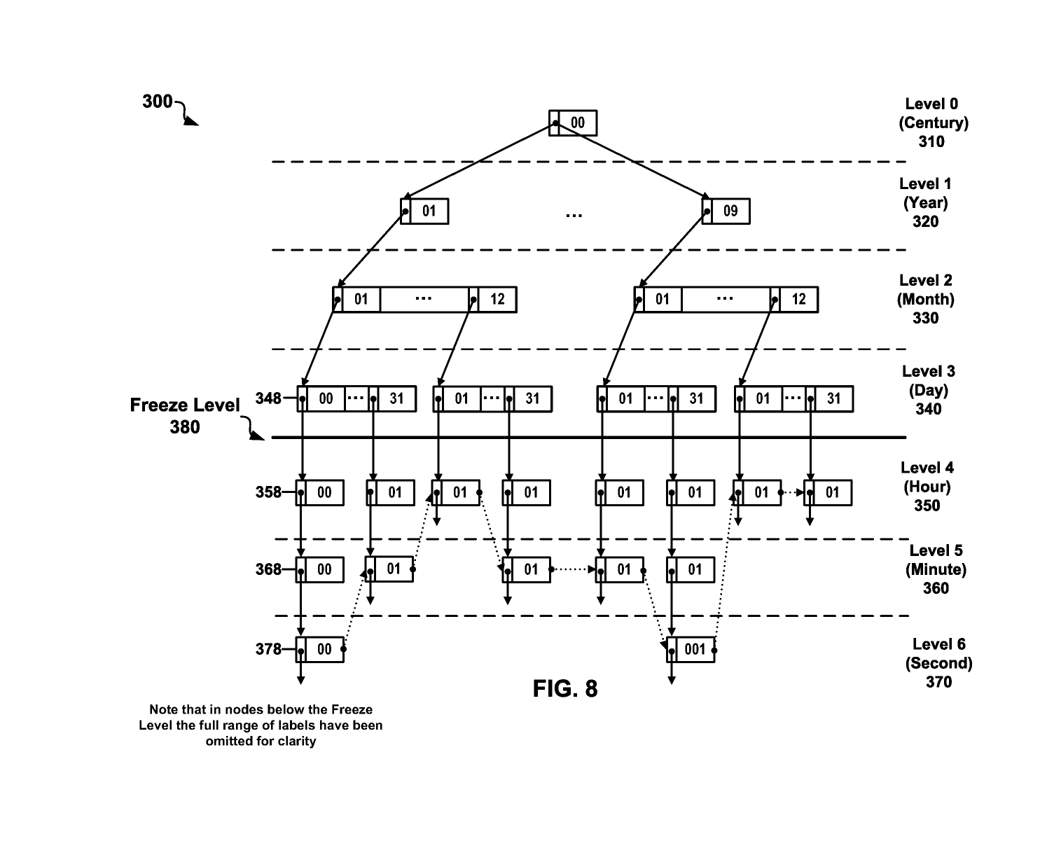

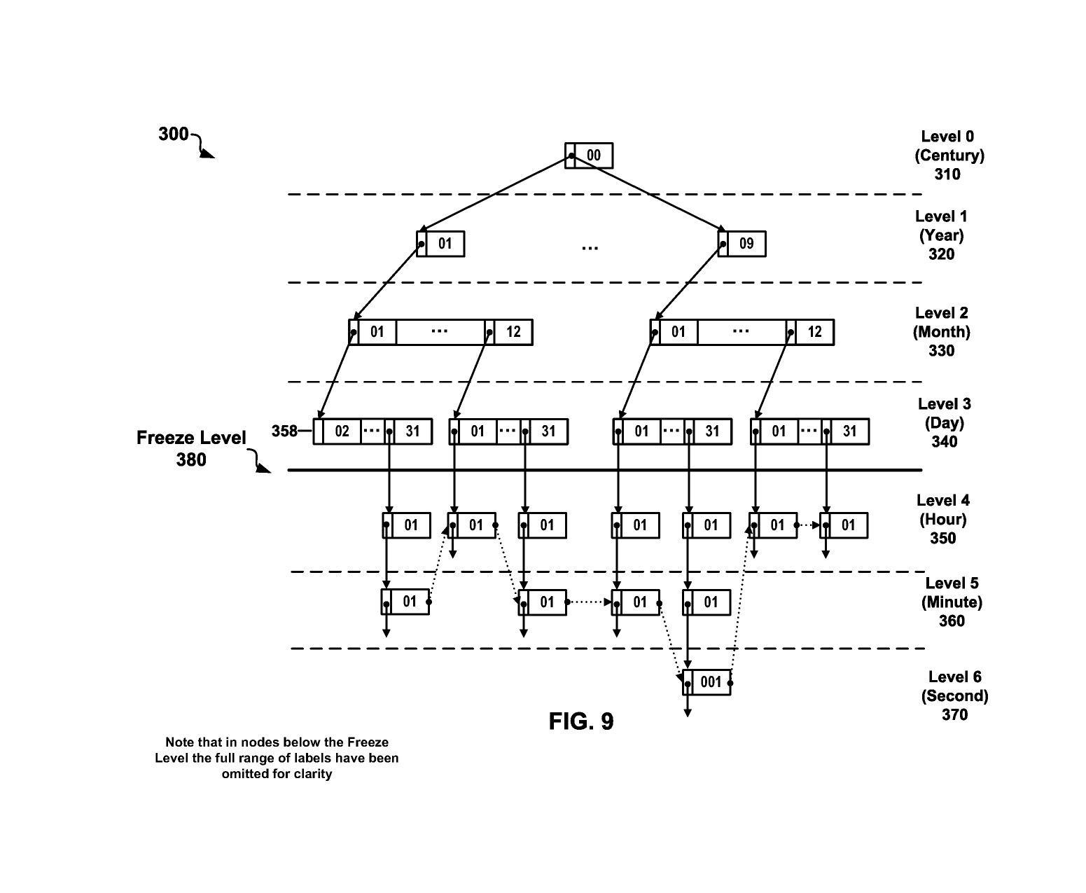

By way of non-limiting example, consider the unbalanced time tree index 300 in FIG. 3. FIG. 8 illustrates the index 300 after all index entries relating to century “00”, year “00”, month “01”, date (day) “01”, hour “01” and minute “01” have been deleted. All labels in the leaf node at the level 378 have been set to “00”. Assuming that the deleted index entries refer to all data under century “00”, year “00”, month “01” and day “01” (node 348, entry “01”), leaf node and index node entries in nodes 358, 368 and 378 are all set to “00” (in some embodiments, “000” may be a valid millisecond value), and the “01” entry for the index node 348 at the day (date) level is set to “00”. When the index is reorganized, nodes having all “00” entries and node entries set to “00” can be removed from the index, as illustrated in FIG. 9. As in the case of an balanced tree index, the same effect can be achieved by reorganizing the entire index, or only that portion of the index under century “00”, year “00”, month “01” and day “01”.

In various embodiments, a balanced time tree or an unbalanced time tree can be used to index a table on a date or a date and time. In the case of a table indexed on date, the freeze level can be established at the date level as illustrated in FIG. 2 (balanced) and FIG. 3 (unbalanced). In the case of the balanced tree index illustrated in FIG. 2, below the freeze level, the leaves are all at the hour level (i.e. no records are added at the minute level or below) and hence, a such a balanced time tree is limited to 24 hour-level entries per date. For such entries, the hour may or may not be significant.

For example, for data records reflecting hourly values, the leaf index value could refer to an hour in the day (e.g. 12 for noon). On the other hand, the leaf index value may actually be a simple sequence number under the date (e.g. “5” being the fifth transaction on a date, not a transaction occurring at 5:00 AM). Thus, a balanced time tree frozen on date could be suitable, for example, for a database which is designed for storing a single record for a given date (e.g. daily sales), storing a single record for every hour of a given date (e.g. hourly traffic), or the like.

On the other hand, a balanced time tree frozen at the date level is less suitable for date stamped transactions where there may be more than 24 transactions per date. In such case, if 25 or more transactions are received for a given day, the tree would need to be reorganized to a freeze level of minutes, otherwise, the excess transactions must be discarded, consolidated with other transactions for the same day, allocated to a different date, or otherwise disposed of. When the total transactions being added exceeds the capacity of the node at the freeze level, determined by the branching factor, the freeze level can be pushed down to the next level to accommodate additional transactions. In that case, all the T-Points for all leaves can be extended by adding the label for the next level, and index tree may be reorganized, as appropriate.

In some embodiments, such as those in which a balanced tree is being evaluated for extension to a new freeze level, an unbalanced time tree frozen at the date level, such as that shown in FIG. 3 may be more suitable. Below the freeze level, the leaves may be at the hour level, 350, minute level 360, second level 370 and millisecond level (not shown). As such, a tree can accommodate up to 86,400,000 transactions per date (24 (hours)×60 (minutes)×60 (Seconds)×1000 (microseconds)). For such entries, the hour, minute, second and milliseconds may or may not be significant. For example, for data records reflecting hourly values, the leaf index value could refer to an hour, minute, second or millisecond in the day, or may simply be simple sequence number under the date.

Such flexibility can provide significant saving over a balanced tree index. If a balanced tree table frozen at date level is reorganized to be frozen at the hour level, the index path to every record is be increased by one node, whereas in the case of an unbalanced tree, additional nodes are only added to the index path for dates having more than 24 transactions.

In one embodiment, a time tree index can be used to index a table on a unique key value that can be transformed to, or derived from, a unique date. For example, assume that there are 10 records added to an Employee database table on a particular date, Jan. 1, 2010, where an Employee ID is a 6 digit primary key. If the table is indexed by a time tree index frozen at date level, the T-Points for 10 entries under Jan. 01, 2010 could be:

TABLE 2
T-Point
10010101
10010102
10010103
10010104
10010105
10010106
10010107
10010108
10010109
10010110

Where each T-Point is expressed as YYMMDDHH. In this case, the hour simply represents a count underneath the date, and not an actual hour of creation, although in other embodiments, the hour could represent an hour of entry. In either case, no more that 24 entries can be created under a given date.

These T-Points could be mapped to a unique, six digit Employee ID using a function T wherein:

T(Record Key)=T-Point

For example T(100111)=10010101
T(100112)=10010102

TABLE 3

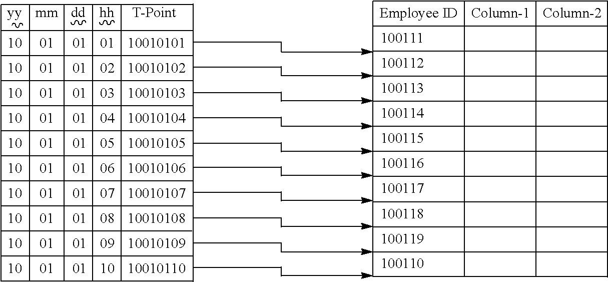

In one embodiment, mapping between a T-Point and a unique ID could be purely algorithmic, which is to say, determined using only the numbers in the T-Point or the record key. In the above example, for example, the first two digits of the Employee ID could represent the two-digit year in the T-Point, and the mm, dd, and hh of the T-Point could be combined in some manner to create a unique 4 digit number. The advantage of such an embodiment is that the index itself inherently enforces the uniqueness of the record key. In other embodiments, the T-Point value itself could be a unique 8 digit record key that makes it easier to handle the field values that are duplicates in the database records. In still other embodiments, any mapping algorithm that maps the field value to the T-Point string can be used.

Note that in the above examples, if a balanced time tree index frozen at a date level is used, if the number of employees added exceeds 24 for a given day, the index frozen at date will not be able to index such records using T-Points of the date of the record addition. In the case of a relatively small company, this could be a reasonable assumption, and on an exception basis, if the number of records added occasionally exceeds 24, overflow records could be added to the following day. If an unbalanced time tree is used, on the other hand, if the number of employees added exceeds 24 for a given day, the index can add leaf nodes at the minute level and accommodate a much larger number of records.

Alternatively, the T-Point could be an arbitrary number derived from a key value in, for example, a table, where the T-Point does not represent a date of significance to the database record to which it points. Thus, the range of Employee IDs above, 100110-100119, could merely be sequentially assigned numbers assigned over a period of days that are arbitrarily mapped algorithmically to a unique T-Point. In such case, a balanced tree index can be used since the dates reflected in the index can be strictly controlled.

A balanced tree index can be also generated for any non-key/non-primary key fields in database tables. In such indexes, index values do not relate to the time of creation of database records when the index is generated. In one embodiment, the balanced time tree represents the ordered set of the field values corresponding all the records. Such indexes can also support indexing of duplicate values since the T-Points are unique and represent the address of the records that have duplicate values in that field. For the index tree generated on non-primary key fields, addition of the record results in reorganization of the index set. Also, a record updating operation that changes the non-key field value, for which the indexing was created earlier, may result in reorganization of the corresponding index tree.

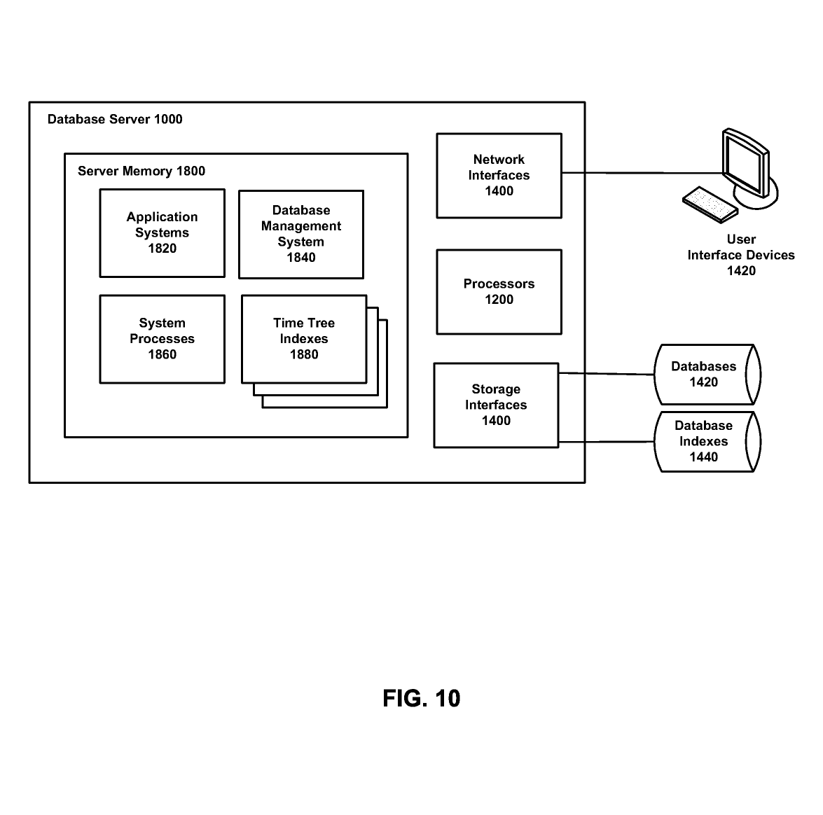

FIG. 10 illustrates one embodiment of a database server 1000 capable of supporting time tree indexing. The database server 1000 has at least one processor 1200. The database server 1000 has at least one network interface 1400 for interfacing with one or more user interface devices 1420. The database server 1000 has at least one storage interfaces 1400 interfacing with one or more storage devices storing one or more databases 1420 and database indexes 1440 on computer readable media. In one embodiment, at least some of the database indexes 1440 are balanced time tree indexes.

The server 1000 hosts a plurality of processes in server memory 1800. Such processes include system processes 1860, such as operating systems processes, database management system processes 1840, and application system processes 1820. In one embodiment, the database management system processes 1840 create and maintain the databases 1420 and the database indexes 1440.

In one embodiment, index nodes of time tree indexes could be implemented as data structures stored on computer readable media 1440, where a given node could be stored as an individual block of data referencing a parent node and one or more child nodes. Alternatively, nodes in one or more levels of a time tree index could be represented as entries in an array stored in processor memory 1880. For example, on a balanced tree index for a date, nodes down to date could be represented as entries in a three-dimensional array, where the dimensions of the array are year, month and date, and the entries in the array that are populated contain pointers to nodes at the next lowest level. This reduces the total number of index pages that are required to represent the index tree, which in turn lowers the total disk page reads during a record search.

The address to a particular date node can be directly found in the array as Address (year, month and date). In such an embodiment, the array grows every year. Irrespective of the size of the tree (number of year it represents) the search for a record is always in the pool of the records under given a date node. Assuming a balanced time tree frozen at date level is fully loaded, on each date there can be 24*60*60=86400 records up to seconds level, and thus, searching for a record that falls in a particular date requires searching the pool of 86400 records.

In one embodiment, in-memory arrays such as an Address (year, month and date) can be periodically, or continuously saved to a persistent storage device, such as the storage device shown in 1440 of FIG. 4, for recovery in the event of a system crash, or for quick restart of indexing after planned outages (e.g. stop and restart of the database management process). Alternatively, if index records below the lowest level of the array are reliably saved (e.g. via a 2 phase commit), an in memory array could be rebuilt from stored index nodes and key values stored in data records.

Table 4 illustrates one embodiment of the memory and/or storage requirements for a fully populated time tree index, populated down to the millisecond level, where the portion of the index down to the date (day) level is stored as a three dimensional array.

TABLE 4
Memory requirements at each level for 1 Date(day)

| | | | | | | Total | Maximum Number of |
|---|---|---|---|---|---|---|---|
| | Total lables for | Bytes required | | | Cumulative | Pages(4 KB) | records that can be |
| | Nodes at each | for each lable in | Total Bytes | Memory | memory for each | required for | stored for a date at |
| Tree level | level | the node | Required | Required in KB | level in KB | each level | each level. |
| month | 1 | 0 | | | 0 | | |
| date | 1 | 4 | 4 | 0.00390625 | 0.00390625 | 0.000976563 | |
| hour | 24 | 10 | 240 | 0.234375 | 0.23828125 | 0.059570313 | 24 |
| minute | 1440 | 10 | 14400 | 14.0625 | 14.30078125 | 3.575195313 | 1440 |
| second | 86400 | 10 | 864000 | 843.75 | 858.0507813 | 214.5126953 | 86400 |
| milli second | 86400000 | 13 | 1123200000 | 1096875 | 1097733.051 | 274433.2627 | 86400000 |
| | Total | | 1124078644 | 1097733.051 | | 274433.2627 | |

In the illustrated embodiment, such an array requires only 14.0625 KB to store entries for 1 year. For every year added to the index, another 3 dimensional date array is created to index nodes at the second level and below. In the illustrated embodiment, nodes below the day level are maintained as indexes 1440 stored on computer readable media.

Note that, in one embodiment, intermediate nodes store pointers to the next level. Navigation from one level to the next level can be achieved by searching for a T-Point substring that is equal to the value being searched and using the pointer stored at that node to navigate to a node at the next level of the index. In the embodiment illustrated in Table 4, year, month and day are stored in a three dimensional array. The memory requirement can be calculated for 365 locations holding pointers to 365 days in a year. In one embodiment, the memory requirement is 4 bytes for each date (e.g. the size of a pointer).

In one embodiment, a searching method in time tree index is a binary search at each level, and the total time complexity for search can be computed by adding the individual complexities at each level. Table 5, below, details the time complexities associated with searching different levels for a balanced tree of one year. The complexity does not increase significantly when the index expands to include subsequent years.

TABLE 5

| | | Cumulative | |
|---|---|---|---|
| | | Time | Maximum |
| | | complexity | Number of |
| | Time | required at | records at |
| | Complexity | each level | each level |
| Tree Level | at each level | ( ) | under a date |
| Search at the hour level | (log 24) = | 4.5849 | 8,760 |
| [01, 02, 03 . . . 24] | 4.5849 | | |
| Search at the Minute | log 60) = | 10.4917 | 525,600 |
| level [01, 02, 03 . . . 60] | 5.9068 | | |
| Search at the Second | log 60) = | 16.3985 | 31,536,000 |
| level [01, 02, 03 . . . 60] | 5.9068 | | |
| Search at the Milli | (log 1000) = | 26.8735 | 31,536,000,000 |
| Second level [000, 001, | 9.9657 | | |
| 002, 003 . . . 999] | | | |

In the embodiment illustrated in Table 5, the best case scenario is searching for records at hour level (4.5849) and the worst case scenario is searching for records at the millisecond level (26.3628).

In a balanced time tree, the total number of records in the table can be divided into the mutual exclusive sets by year by creating individual 3-dimensional date arrays 1880 for each year. To locate a record for a given year, the path is fixed from year to date in an in-memory array representing the year. Using this direct path the search converges from the pool of the total records of one year to the small set of records of a date. The time complexity is less than O(log 24)+O(log 60)+O(log 60)=16.3 irrespective of the size of the tables for accessing records at seconds level. Hence, whether the tables indexed by a time tree contain 2 million records or 10 million records, the tables will have essentially the same time complexities for record search.

The memory requirement for implementing such an index is small compared to a conventional B+-Tree since, in the case of the B+-Tree, the key value is typically stored in the tree. In time indexes, where year, month and date levels are stored in an array, that is typically of a fixed size of 365 elements. Thus, in some embodiments, the total memory required for such an array is 1.5 KB. Such an array can provide direct access to the Date level nodes. In one embodiment, in any record pool comprising up to 31,536,000 (31 million) records, individual records can be located with 4 disk page reads (3 index pages and 1 for record page). This is significantly more efficient than B+ tree memory requirements.

In the case of a time index, in many embodiments records will be added only at the right end of a balanced time tree index. Thus, the index will not typically require reorganization as index values will not change for existing records. The addition of a database record on a particular date will not change the T-Points of the records added on previous dates. If, however, records are added beyond the capacity of the level, a balanced tree index will need to be expanded to the next level (e.g. for an index at minute level, this means expanding to a second level). In such a case, a new second level will be defined for the entire tree, and the index will need to be reorganized to accommodate new T-Point mapping to a lower date level. For non-cluster indexing, records can be added in any place in the tree based on the position the field value takes in the ordered set. In such embodiments, every time a record is added, reorganization may be required.

The need for index tree reorganization can be minimized through proper index design. Where a balanced time-tree index is intended to represent an actual date and time of a transaction or an event, the number of levels of the index can be selected such that the capacity of the lowest index will not be exceeded. For example, if events or transactions never occur at a rate of more than one per second, a balanced time tree index can be defined with leaves at the second level.

If a balanced time tree index is used to represent a key value that is mapped to an arbitrary time (e.g. a unique key 100111 is mapped to 10/01/01/01), the capacity of the lowest index will never be exceeded for any given date, since the T-Point of each record is under the control of processes adding records to the database. However, the capacity of the index as a whole could easily be exceeded. For example, for an index having leaves at the hour level, there are a total of 8,760 T-Points for a given year, and if the index is defined with a two digit century, the overall maximum number of T-Points is 100*8,760=876,000. In a large database, this number could be exceeded. In such cases the need for reorganization could be avoided, for example, by defining an index with sufficient levels to accommodate values for every database record expected to be indexed.

In one embodiment, at a high-level, for a non-cluster index, the process of creating time tree index for the database table can be summarized as follows. The total number of records the database table will contain is determined. Based on this the smallest time unit the time tree index must support is identified. The size of the balanced tree is determined, defining the depth of the tree and the T-Point Length. The index is then defined and records are added to the index.

In one embodiment, at a high-level, for time index, the process of adding a record to a time tree index is as follows. The date and time stamp of the record and the address of the record are determined. A T-Point is then created based on the date and time provided. As required, nodes are created in the index tree corresponding to each time unit within the T-Point. A leaf node corresponding to the T-Point is then added to the index tree. The leaf node is then updated with the address of the record.

In one embodiment, at a high-level, the process of retrieving a database record using tree index when date or time is provided is as follows. A date/time is provided. A T-Point based on the time/date value is created, considering, among other things, the T-Point length defined for the tree. All the records under the node represented by the T-Point are returned. Example, if Jan. 10, 2010 is provided, then all the leaf nodes under that date are returned. If an hour is provided, then T-Point is created down to such hour and all the leaf nodes under that hour are returned. When the key is provided to search a record, first the T-Point is derived from the key by a mapping algorithm. Then, using this T-Point, the record is retrieved from the index tree that was created for the key filed.

These processes will now be described in detail.

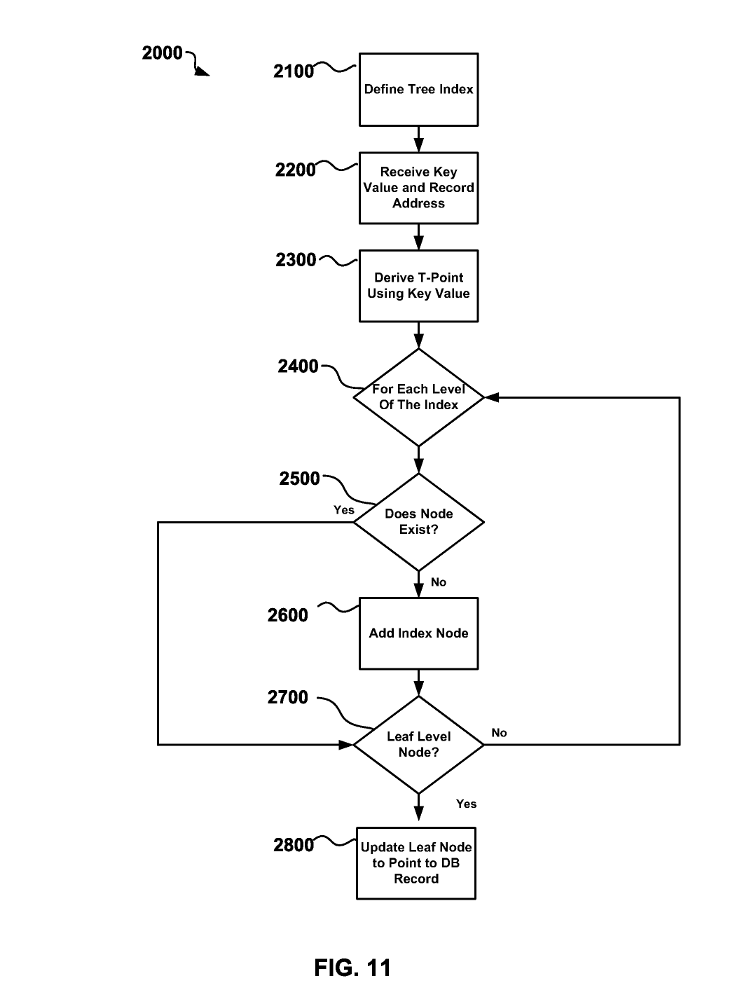

FIG. 11 illustrates one embodiment of a process 2000 for creating, building and using a tree index.

In block 2100 of the process, a tree index is defined for a database table. In one embodiment, the index is a balanced time tree index. One definition of a balanced time tree index is as follows:
the index has N levels (N being greater than 1), beginning at level 0, such that L=0, 1, 2, . . . N-1, each level representing a time unit selected from the list: century, year, month, date, hour, minute, second and millisecond;
the root level of the index represents the time unit of century and is level 0;
the N levels are arranged in hierarchical order from largest to smallest time unit such that for a given level L, the next level, L+1 is the next smallest time unit;
the level N-2 is a freeze level for the index, such that leaf nodes are added at the index level corresponding to level N-1.

In one embodiment, the index is an unbalanced time tree index. One definition of a unbalanced time tree index is as follows:
the index has N levels (N being greater than 1), beginning at level 0, such that L=0, 1, 2, . . . N-1, each level representing a time unit selected from the list: century, year, month, date, hour, minute, second and millisecond;
the root level of the index represents the time unit of century and is level 0;
the N levels are arranged in hierarchical order from largest to smallest time unit such that for a given level L, the next level, L+1 is the next smallest time unit;
the level N-2 is a freeze level for the index, such that leaf nodes are added at a plurality of index levels below the freeze level.

As discussed above, individual nodes within the index could be stored as data structures stored on a computer-readable medium using the node structure illustrated in FIG. 4, or alternatively, one or more levels of the index could be represented as an array stored in processor memory.

In block 2200 of the process, a key value and record address are received for a database record added to a database table. In one embodiment, the key value could be a unique, primary key or secondary key for the database record. In one embodiment, the key value could be a non-unique secondary key for the database record or a non-unique, non-key field.

It is understood that, in alternate embodiments, when a key value or values is received for a database record, the database record may not yet have been added to the database, and the address of the database record may yet be unknown. In one such embodiment, the database record may be added to the database concurrently, or after the leaf index entries pointing to the database record have been added to the index.

In block 2200 of the process, a T-Point value is derived using the record key. In one embodiment, the T-Point is a timestamp representing a timestamp value whose smallest time unit is one level below the freeze level of the index, which is to say, it defines a path to a leaf node of the index.

The derivation of the T-Point value is dependant on the nature of the index. In one embodiment, the index defines a timestamp when a record was added to the database. In such case, the derivation of the T-Point is straightforward. For example, in the case of an index down to the second level, if the record was added on Jun. 12, 2010 at 11:52:03 AM, the T-Point for the record addition could be “00100612115203” (e.g. CCYYMMDDHHMMSS).

In one embodiment, if the date and time of the record addition is provided for a larger time unit than the index level immediately below the freeze level, the T-Point could be assigned values down to such level by arbitrarily incrementing a T-Point representing the key value of the database record by the lowest time unit of the index. For example, if an index supports entries to the seconds level (e.g. a freeze level in a balanced time tree at the minute level), but dates in database records are only known to the minute level, then the second value in the T-Point could be arbitrarily assigned, for example, the seconds could be set to “01” and incremented by one for every index value received for the same minute.

In one embodiment, if the date and time of the record addition is provided for a smaller time unit than the full depth of the index, the key value could be rejected, or alternatively, the T-Point could be truncated or rounded to a time unit representing the full depth of the index. For example, if an index supports entries to the seconds level (e.g. a freeze level in a balanced time tree at the minute level or an unbalanced tree whose full depth is down to the second level), but dates in database records are only known to the minute level, then the second value in the T-Point could be arbitrarily assigned, for example, the seconds could be set to “01” and incremented by one for every index value received for the same minute.

In other embodiments, a T-Point value could be algorithmically determined from a unique key value, such as that illustrated above with reference to employee IDs. For example, an employee ID of “100111” could be mapped to a century of 00 (default), a year of 10, and months, days and hours of “1”. The unique key value itself may or may not have been derived from an actual date or time. It could simply represent an arbitrarily incremented sequence number, a date a database record was added or modified (e.g. the first employee added on Oct. 10, 2010), or the like.

Once a T-Point is determined, the database index can be updated. For each level 2400 of the index, beginning at the root of the index, it is then determined if a node reflecting the respective level of the T-Point value exists. For example, given a T-Point of “10010101” (e.g. Jan. 01, 2010, 1:00 AM), it is determined, in sequence, if index nodes exist for a year of “10”, a month of “01”, a day of “01” and an hour of “01”.

At each index level, if the respective index node does not exist 2500, the index node reflecting the respective level of the T-Point value to the index is added 2600 such that the index node points to a parent node corresponding to a node reflecting the respective next largest value of the time point value, and the parent node points to the index node. It should be understood that by the term “node” could refer to a data structure stored on a computer readable medium, or could, alternatively refer to an entry in a node array, as described above. When the leaf-level node of an index path representing the T-Point has been reached (or created) 2700, the leaf is updated 2800 to point to the database record. In one embodiment, if the leaf already points to a another record address, the key value is rejected.

In one embodiment, if the tree index is a non-cluster index, the T-Point is determined as described above down to the time unit equivalent to the freeze level for the index. The next available T-Point value under the node corresponding to the key value is then determined, and the index is updated, for example, as shown in blocks 2400-2800 above.

In one embodiment, the next available T-Point value is determined as follows. The leaf node corresponding to the highest T-Point value under the node identified by the key value is located. This T-Point is then incremented by one unit of the time unit corresponding to the time unit of the leaf node. For example, if the highest T-Point under a date 2010-10-20 is 2010102015, the next available T-Point is 2010102016 (incrementing the T-Point by an hour).

If the T-Point corresponds to the last possible value under a leaf node, then a new leaf node is required. Consider the example above. If the highest T-Point under a date 2010-20-30 is 2010102024, the leaf node cannot support any more T-Points, and a new leaf node must be created to index the key-value. How such a situation is handled depends on whether a balanced or unbalanced tree index is used.

In one embodiment, regardless of whether a balanced or unbalanced tree index is used, a new leaf node is created at the next lowest level of the index. The consequences of such an operation in a balanced tree index are relatively severe. In the example above, if the balanced tree index is frozen on day/date, the freeze level of the index must be decreased to at least the hour level (with leaf nodes at the minute level). Following reorganization, the next available T-Point can then be determined and the index updated as described above.

By contrast, in an unbalanced tree, if the leaf node resides above the lowest level of the index, in one embodiment, the portion of the index tree under the index node corresponding to the key value is reorganized to a depth of the next lowest level of the index. Following reorganization, the next available T-Point can then be determined and the index updated as described above. If the leaf node already resides at the lowest level of the index, in one embodiment, the depth of the index is increased and the portion of the index tree under the index node corresponding to the key value is reorganized, or the entire index is reorganized.

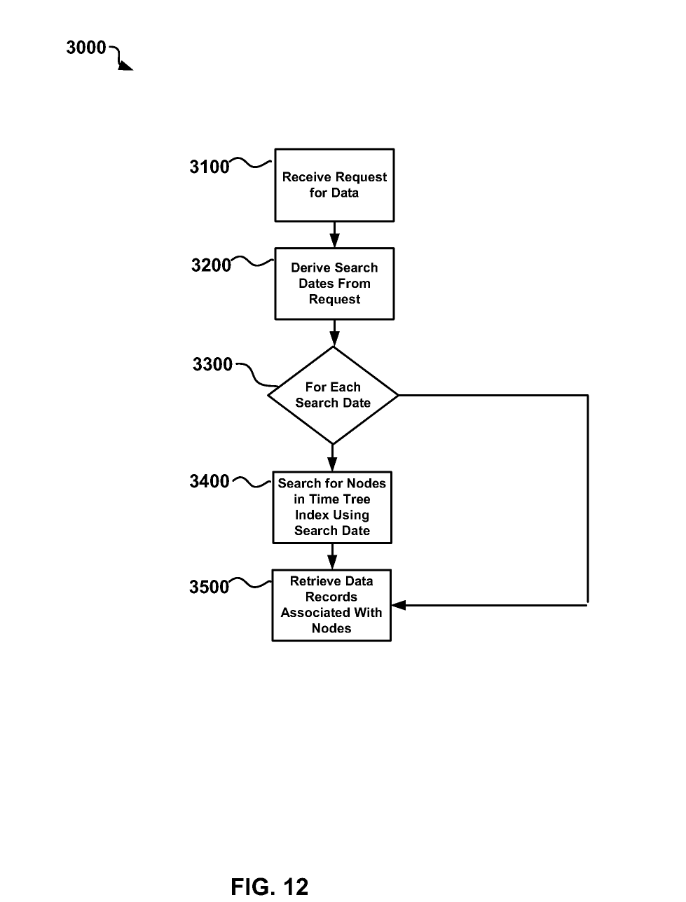

FIG. 12 illustrates one embodiment of a process 3000 for searching a time tree index for data relating to a key value. In various embodiments, the processes can be used to search both balanced and unbalanced time tree indexes.

In block 3100 of the process, a request for data is received, using a computing device, the request comprising a search value. In one embodiment, the search value can represent a timestamp or date value, such as, for example, the date a record was added to a database, or a key value that is not a timestamp or date value, but which can be converted to a date value algorithmically.

In block 3200 of the process, a search date is derived, using the computing device, from the search value, the search date comprising at least one time unit selected in order from a largest time unit to a smallest time unit, the at least one time unit selected from the list: century, year, month, date, hour, minute, second and millisecond.

In one embodiment, the search value is a timestamp value, and the search date is derived by converting the timestamp value to a date format. In one embodiment, the search value is not a timestamp or date value and the search date value is derived from the search value using a mapping algorithm, an example of which is discussed above.

The processing of blocks 3400 and 3500 can be repeated 3300 for each search date derived in block 3200. In block 3300 of the process, a time tree index is searched for at least one node in the index such that the index path to the one node comprises the search date. In one embodiment, the time tree index is a balanced time tree index. In one embodiment, the time tree index is an unbalanced time tree index. In the case where the search is in a non-cluster index tree, then the T-Point labels are used to navigate in the tree until either the leaf node is located or the T-Point labels are completed.

In block 3400 of the process, data record(s) associated with the nodes located in block 3300 are retrieved. In one embodiment, one or more nodes are leaf nodes. In one embodiment, non-leaf nodes comprise at least one leaf node entry, each leaf node entry comprising a leaf node entry label and a data record pointer. In one embodiment, if one of the leaf node entries is identified such that the leaf node entry label is equal to the value of the smallest time unit of the search date, the data record pointer of the respective leaf node entry is used to retrieve the data record.

In one embodiment, a node retrieved in block 3300 is a non-leaf node. In one embodiment, non-leaf nodes comprise at least one non-leaf node entry, each non-leaf node entry comprising a non-leaf node entry label and a child node pointer. If one of the non-leaf node entries is identified such that the non-leaf node entry label is equal to the value of the smallest time unit of the search date, the child node record pointer of the respective entry is used to retrieve a child node. If the child node is a leaf node comprising at least one leaf node entry, a data record is retrieved for each of the leaf node entries using the respective data pointer of the leaf node entry.

In one embodiment, a node retrieved in block 3300 is a non-leaf node that has a plurality of child nodes, wherein a subset of the plurality of child nodes comprises a plurality of leaf nodes. Each leaf node comprises at least one leaf node entry comprising a leaf node entry label and a data record pointer. For each of the plurality of leaf nodes, a data record is retrieved for each of the leaf node entries in the respective leaf node using the respective data pointer in the leaf node entry.

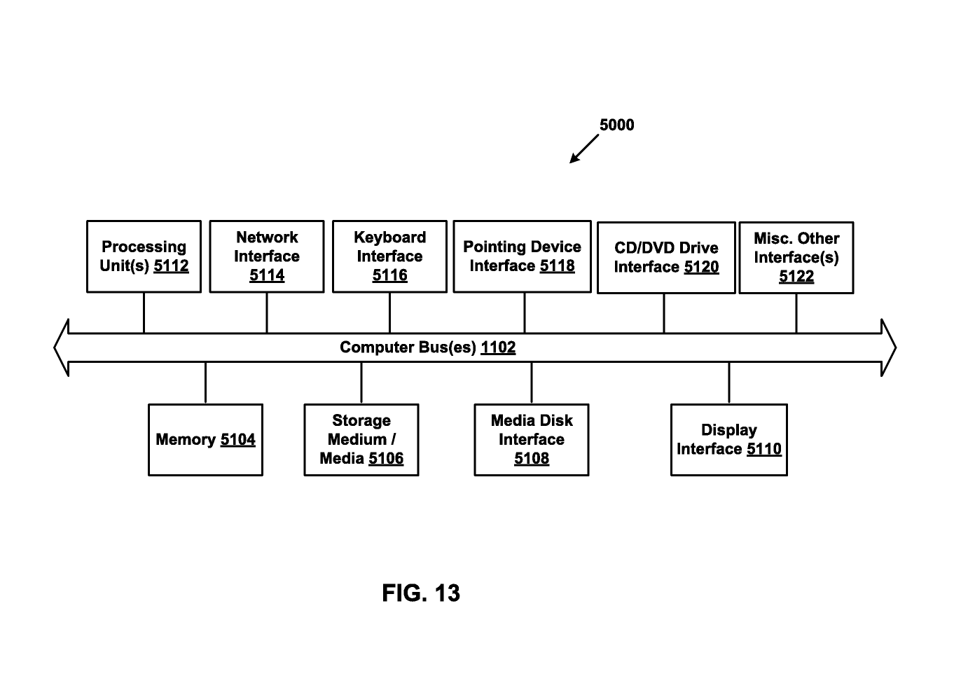

FIG. 13 is a block diagram illustrating an internal architecture of an example of a computing device 5000, such the database server of FIG. 10, in accordance with one or more embodiments of the present disclosure. A computing device as referred to herein refers to any device with a processor capable of executing logic or coded instructions, and could be a server, personal computer, set top box, smart phone, tablet computer or media device, or other such devices. As FIG. 13 illustrates, the internal architecture 5100 includes one or more processing units (also referred to herein as CPUs) 5112, which interface with at least one computer bus 5102. Also interfacing with computer bus 5102 are persistent storage medium/media 5106; network interface 5114; memory 5104 (e.g., random access memory (RAM), run-time transient memory, read only memory (ROM), etc.); media disk drive interface 5108, which can provide an interface for a drive that can read and/or write to media including removable media (e.g., floppy, CD-ROM, DVD, etc.); display interface 5110, which can provide an interface for a monitor or other display device; keyboard interface 5116, which can provide an interface for a keyboard; pointing device interface 5118, which can provide an interface for a mouse or other pointing device; and miscellaneous other interfaces not shown individually, including, without limitation, parallel and serial port interfaces, universal serial bus (USB) interfaces, and the like.

Memory 5104 interfaces with computer bus 5102 so as to provide information stored in memory 5104 to CPU 5112 during execution of software programs such as an operating system, application programs, device drivers, and software modules that comprise program code, and/or computer-executable process steps, incorporating functionality described herein, e.g., one or more of process flows described herein. CPU 5112 first loads computer-executable process steps from storage, e.g., memory 5104, storage medium/media 5106, removable media drive, and/or other storage device. CPU 5112 can then execute the stored process steps in order to execute the loaded computer-executable process steps. Stored data, e.g., data stored by a storage device, can be accessed by CPU 5112 during the execution of computer-executable process steps.

Persistent storage medium/media 5106 comprises one or more computer readable storage medium(s) that can be used to store software and data, e.g., an operating system and one or more application programs. Persistent storage medium/media 5106 can also be used to store device drivers, such as one or more of a digital camera driver, monitor driver, printer driver, scanner driver, or other device drivers, web pages, content files, playlists and other files. Persistent storage medium/media 5106 can further include program modules and data files used to implement one or more embodiments of the present disclosure.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
receiving, using a computing device, a request for data, the request comprising a search value;
deriving, using the computing device, a search date, a search date from the search value to comprising at least one time unit selected in order from a largest time unit to a smallest time unit, the at least one time unit selected the list: century, year, month, date, hour, minute, second and millisecond;
searching, using the computing device, a time tree index for at least one node, such that the index path to the at least one node comprises the search date; and
retrieving, using the computing device, at least one data record associated with the at least one node.

2. The method of claim 1 such that the at least one node is a leaf node comprising at least one leaf node entry, each leaf node entry comprising a leaf node entry label and a data record pointer, such that one of the at least one leaf node entries is identified such that the leaf node entry label is equal to the value of the smallest time unit of the search date, such that the data record pointer of the one of the at least one leaf node entries is used to retrieve the at least one data record.

3. The method of claim 1 such that the at least one node is a non-leaf node comprising at least one non-leaf node entry, each non-leaf node entry comprising a non-leaf node entry label and a child node pointer, such that:
one of the at least one non-leaf node entries is identified such that the non-leaf node entry label is equal to the value of the smallest time unit of the search date, such that the child node record pointer is used to retrieve at least one child node, such that
if the child node is a leaf node comprising at least one leaf node entry, each leaf node entry comprising a leaf node entry label and a data record pointer, a data record is retrieved for each of the at least one leaf node entries using the respective data pointer.

4. The method of claim 1 such that the at least one node is a non-leaf node such that the non-leaf node has a plurality of child nodes, wherein a subset of the plurality of child nodes comprises a plurality of leaf nodes, each leaf node comprising at least one leaf node entry, each leaf node entry comprising a leaf node entry label and a data record pointer, such that for each of plurality of leaf nodes, a data record is retrieved for each of the at least one leaf node entries in the respective leaf node using the respective data pointer.

5. The method of claim 1 such that
the time tree index has N levels, beginning at 0 such that L=0, 1, 2, . . . , N-1, each level representing a time unit selected from the list: century, year, month, date, hour, minute, second and millisecond,
a root level of the time tree index represents the time unit of century and is level 0,
the time tree index has at least 2 levels;
the N levels are arranged in hierarchical order from largest to smallest time unit such that for a given level L, the next level, L+1 is the next smallest time unit,
the level N-2 is a freeze level for the index, such that leaf nodes are added at the index level corresponding to level N-1.

6. The method of claim 5 such that the first M levels of the index, where M is less than N, are represented as an M-dimensional array stored in a processor memory, and individual array elements point to index nodes at level M and the nodes of level M and the remaining levels of the index are persistently stored on a computer readable medium.

7. The method of claim 1 such that such that the search value represents a timestamp value for when a record was added to a database, and the search date is derived by converting the timestamp value to a date format.

8. The method of claim 1 such that the search value is not a timestamp or date value and the search date value is derived from the key value using an algorithm.

9. A computing device comprising:
a processor;
a time tree index stored on computer readable storage media;
a storage medium for tangibly storing thereon program logic for execution by the processor, the program logic comprising:
request logic for receiving a request for data, the request comprising a search value;
date derivation logic for deriving a search date, a search date from the search value to comprising at least one time unit selected in order from a largest time unit to a smallest time unit, the at least one time unit selected the list: century, year, month, date, hour, minute, second and millisecond;
search logic for searching a time tree index for at least one node, such that the index path to the at least one node comprises the search date; and
data retrieval logic for retrieving at least one data record associated with the at least one node.

10. The computing device of claim 9 such that the at least one node is a leaf node comprising at least one leaf node entry, each leaf node entry comprising a leaf node entry label and a data record pointer, such that one of the at least one leaf node entries is identified such that the leaf node entry label is equal to the value of the smallest time unit of the search date, such that the data record pointer of the one of the at least one leaf node entries is used to retrieve the at least one data record.

11. The computing device of claim 9 such that the at least one node is a non-leaf node comprising at least one non-leaf node entry, each non-leaf node entry comprising a non-leaf node entry label and a child node pointer, such that:
one of the at least one non-leaf node entries is identified such that the non-leaf node entry label is equal to the value of the smallest time unit of the search date, such that the child node record pointer is used to retrieve at least one child node, such that
if the child node is a leaf node comprising at least one leaf node entry, each leaf node entry comprising a leaf node entry label and a data record pointer, a data record is retrieved for each of the at least one leaf node entries using the respective data pointer.

12. The computing device of claim 1 such that the at least one node is a non-leaf node such that the non-leaf node has a plurality of child nodes, wherein a subset of the plurality of child nodes comprises a plurality of leaf nodes, each leaf node comprising at least one leaf node entry, each leaf node entry comprising a leaf node entry label and a data record pointer, such that for each of plurality of leaf nodes, a data record is retrieved for each of the at least one leaf node entries in the respective leaf node using the respective data pointer.

13. The computing device of claim 9 such that
the time tree index has N levels, beginning at 0 such that L=0, 1, 2, . . . , N-1, each level representing a time unit selected from the list: century, year, month, date, hour, minute, second and millisecond,
a root level of the time tree index represents the time unit of century and is level 0,
the time tree index has at least 2 levels;
the N levels are arranged in hierarchical order from largest to smallest time unit such that for a given level L, the next level, L+1 is the next smallest time unit,
the level N-2 is a freeze level for the index, such that leaf nodes are added at the index level corresponding to level N-1.

14. A computer-readable storage medium comprising for tangibly storing thereon computer readable instructions for a method comprising:
receiving, using a computing device, a request for data, the request comprising a search value;
deriving, using the computing device, a search date, a search date from the search value to comprising at least one time unit selected in order from a largest time unit to a smallest time unit, the at least one time unit selected the list: century, year, month, date, hour, minute, second and millisecond;
searching, using the computing device, a time tree index for at least one node, such that the index path to the at least one node comprises the search date; and
retrieving, using the computing device, at least one data record associated with the at least one node.

15. The computer-readable storage medium of claim 14 such that the at least one node is a leaf node comprising at least one leaf node entry, each leaf node entry comprising a leaf node entry label and a data record pointer, such that one of the at least one leaf node entries is identified such that the leaf node entry label is equal to the value of the smallest time unit of the search date, such that the data record pointer of the one of the at least one leaf node entries is used to retrieve the at least one data record.

16. The computer-readable storage medium of claim 14 such that the at least one node is a non-leaf node comprising at least one non-leaf node entry, each non-leaf node entry comprising a non-leaf node entry label and a child node pointer, such that:
one of the at least one non-leaf node entries is identified such that the non-leaf node entry label is equal to the value of the smallest time unit of the search date, such that the child node record pointer is used to retrieve at least one child node, such that
if the child node is a leaf node comprising at least one leaf node entry, each leaf node entry comprising a leaf node entry label and a data record pointer, a data record is retrieved for each of the at least one leaf node entries using the respective data pointer.

17. The computer-readable storage medium of claim 14 such that the at least one node is a non-leaf node such that the non-leaf node has a plurality of child nodes, wherein a subset of the plurality of child nodes comprises a plurality of leaf nodes, each leaf node comprising at least one leaf node entry, each leaf node entry comprising a leaf node entry label and a data record pointer, such that for each of plurality of leaf nodes, a data record is retrieved for each of the at least one leaf node entries in the respective leaf node using the respective data pointer.
